(19) United States
(12) Patent Application Publication
(10) Pub. No.: US 2025/0246090 A1
(43) Pub. Date: Jul. 31, 2025

(54) SYSTEM AND METHOD FOR AUTOMATED TRAINING CONTENT AUGMENTATION

(71) Applicant: HSI USA Holding, Inc., Frisco, TX (US)

(72) Inventors: Jose Manuel William Arcilla, McKinney, TX (US); Michael Alan Case, Kennewick, WA (US); John William Hambelton, Eugene, OR (US)

(21) Appl. No.: 19/040,294

(22) Filed: Jan. 29, 2025

Related U.S. Application Data
(60) Provisional application No. 63/626,899, filed on Jan. 30, 2024.

(51) Int. Cl. G09B 7/00; G06F 40/20; G06F 40/58; G10L 13/02

(52) U.S. Cl. CPC G09B 7/00; G06F 40/20; G06F 40/58; G10L 13/02

(57) ABSTRACT

Systems, methods, and computer-readable storage media for automating training content augmentation, and more specifically to using Artificial Intelligence (AI) to analyze media content and generate questions derived from the content. Systems can receive and process media, then generate questions based on the processed media. The systems can then combine the processed media and the newly generated question, resulting in a course about the media.

### CROSS-REFERENCE TO RELATED APPLICATIONS

The instant application is a U.S. Non-Provisional Application that claims priority to U.S. Provisional Application No. 63/626,899, filed Jan. 30, 2024. The entire content of which is incorporated herein by reference.

### BACKGROUND

### 1. Technical Field

The present disclosure relates to automated training content augmentation, and more specifically to using Artificial Intelligence (AI) to analyze media content and generate questions derived from the content.

### 2. Introduction

Learning Management System (LMS) are software platforms which can assist in the management, distribution, and tracking of user training. LMS customers constantly need the ability to provide industry and organization specific training to diverse groups of users, employees, and contractors. However, providing the training with even a single alternative language or closed captioning can be expensive and add time to the production process. Additionally, extra overhead is required to review created materials and write test questions which ensure that the employees and contractors learned the material.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, media; processing the media via at least one processor of the computer system, resulting in processed media; generating, via the at least one processor based on the processed media, at least one new exam question about the media; and combining, via the at least one processor, the processed media and the at least one new exam question, resulting in a course about the media.

A system configured to perform the concepts disclosed herein can include: receiving media; processing the media, resulting in processed media; generating, based on the processed media, at least one new exam question about the media; and combining the processed media and the at least one new exam question, resulting in a course about the media.

A non-transitory computer-readable storage medium configured as disclosed herein can have instructions stored which, when executed by at least one processor, cause the at least one processor to perform operations which include: receiving media; processing the media, resulting in processed media; generating, based on the processed media, at least one new exam question about the media; and combining the processed media and the at least one new exam question, resulting in a course about the media.

### BRIEF DESCRIPTION OF THE DRAWINGS

FIG. 1 illustrates a first example system embodiment;

FIG. 2 illustrates a second example system embodiment;

FIG. 3 illustrates an example of parallel processes within the system;

FIG. 4 illustrates an example method embodiment; and

FIG. 5 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured as disclosed herein provide enhanced training materials with generated examination questions and alternative languages by generating alternative languages of training materials (e.g., generate alternative audio to the audio track of video/audio in a first language, the alternative audio being in a distinct language), closed captioning, and/or examination questions. Using multiple artificial intelligence and machine learning services, video, audio, and text-based documents are uploaded to the system. Submitted media is then queued for extraction, generative content, and translation steps, which are recompiled back into a single consolidate multi-language learning object which can be easily assigned to learners. Learners may then consume the content in non-native languages, enable closed captioning, and be tested via generated exam banks.

Consider the following example. A company needs to provide its employees training on a new subject “X”. A series of video clips have been produced which provide the overall “do this, not that” instruction of the training in English. However, the company needs the training to also be provided in Spanish and French, the company would like closed captioning available for all three languages, and the company needs questions prepared to test the employees' knowledge of subject “X”. Preferably, the exam generation occurs prior to translation of the training materials, such that the system (A) receives media (e.g., videos, text, audio, etc.); (B) processes the received media and develops exam questions based on the media; (C) combines the media and exam questions into a training course; and (D) translates the training course into the required languages.

In accordance with this disclosure, the series of video clips can be uploaded (i.e., uploaded media) to a computer system. The uploaded media can then be analyzed by the system to determine if it is audio, video, and/or text. In this case, because the uploaded media is video having an audio track, the system can process the video and audio tracks. This processing can, for example, include speech to text processing to identify the specific words spoken in the audio tracks (with their corresponding time stamps), resulting in a text transcription of the video's audio track. In some cases, such speech to text processing can include the use of Artificial Intelligence (AI) algorithms such as (but not limited to) neural networks. One of the advantages of such AI algorithms is that they can determine the context of the text in the files, which allows the translations and text-to-speech greater accuracy in pronunciation, inflection, and pace. Based on the text transcription, a closed captioning file can be created in the original language (in this case English), and the closed captioning data can be translated to other languages, resulted in closed captioning files for other languages (in this case Spanish and French). Such translation may also be performed via AI algorithms. The system can then generate a voiceover of those additional languages using the corresponding closed captioning files (again, such voiceover may be generated using an AI algorithm), resulting in audio tracks in Spanish and French, such that users undergoing the training can select their preferred language and hear the translated audio track, with the translation having of the same time stamps as those of the original English audio.

Using the various closed captioning files the system can then generate questions based on the content of the closed captioning files. That is, the system can use an out-of-the-box Large Language Model (LLM; non-limiting examples can include CHATGPT, BING, and GROK), which can (based on the content and the context of a request) generate exam questions. The system can then allow end-users to modify the request to put emphasis on particular subjects or question type modifications. For example, the system can perform a contextual and/or semantic analysis of the closed captioning files and generate examples of both positive and negative behavior of individuals. Based on those positive/negative examples, the system can generate questions (in one or more languages) which can be used to test whether the employee watching the video comprehended the lesson(s) being taught. Such questions can be stored in a database as part of a pool of questions which can be randomly selected by the LMS.

In some configurations, the system can also process the images/frames of the video, performing shape/image recognition on the objects in the video. From this image recognition additional text may be identified, and the system can also identify actions being taken by entities within the video. Such image recognition can be accomplished via one or more AI algorithms. Additional text and/or the actions identified can also be used by the system in forming questions.

Once the newly generated questions have been added to the pool of questions (in all desired languages), the system can signal that the uploaded media has been processed, and that the media can now be presented to employees as a new course. This new course can then be presented as available in the LMS catalog of available courses, with the employees taking the course in their own languages (including the examinations at the end of the course using translated questions from the pool of questions). The available courses within the LMS catalog can be accessed by authorized users for training via the Internet or other networked systems. In this manner, the updated training courses generated using the disclosed systems can allow for online training of diverse individuals located anywhere that has Internet access.

In configurations where text is provided to the system (alone or in addition to audio/video), the system can perform the generation of additional questions in the same manner as described above (e.g., using an AI algorithm for contextual and/or semantic analysis of the text). In addition, if desired, the system can generate translations and/or audio narration of the text in the original language and/or translations, then use those translations and/or audio narrations as part of a course.

Systems configured as disclosed herein can reduce the amount and time of human interaction required to generate a desired course output. However, such systems also provide a technical benefit of reduced network calls and traffic. More specifically, by processing the various files in the manner disclosed herein, the system reduces the number of files which need to be transmitted/moved across a local area network and/or the Internet for processing.

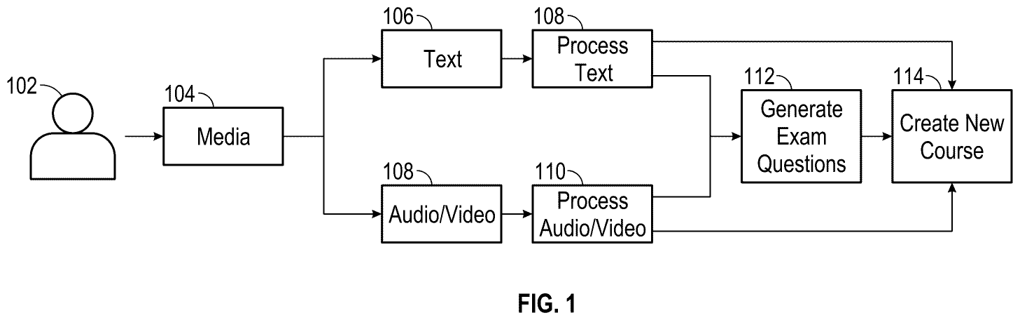

FIG. 1 illustrates a first example system embodiment. In this example, a user 102 provides media 104 to the system. As described above, the media 104 can be text 106, audio/video 108, or some combination thereof. The system processes the text 108 and processes the audio/video 110, then generates exam questions 112 based on the processed text, processed audio, and/or processed video. The system then combines the processed text, processed audio, and/or processed video with the generated exam questions to create a new course 114.

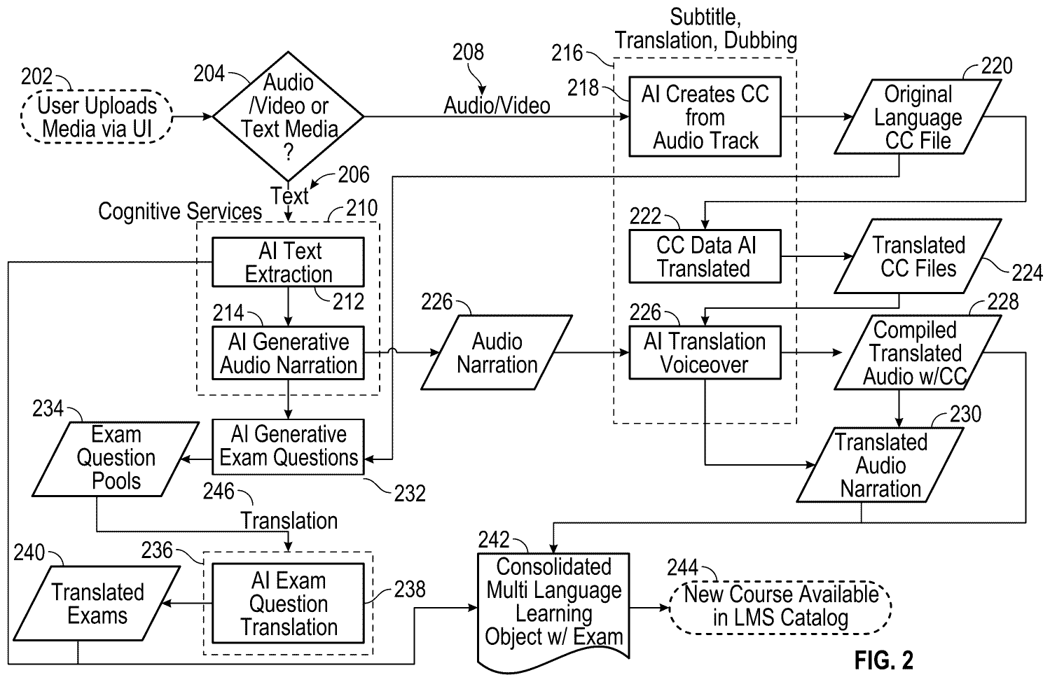

FIG. 2 illustrates a second example system embodiment. In this example, a user uploads media via a User Interface (UI) 202. The system detects if the media is Audio/Video or Text Media 204, or some combination thereof. If the media includes text 206, the system performs cognitive services 210 on the on the text, including an AI text extraction 212 and an AI generative audio narration 214, resulting in an audio narration 226. The AI generative audio narration 214 is a form of text-to-speech conversion, with the AI allowing for improved pacing and pronunciation by using context (compared to a straight conversion of the words). If the media includes audio/video 208, the system performs audio/video processing of generating subtitles, translations, and dubbing 216. First, the system uses AI to create closed captioning (CC) from the audio track, resulting in an original language CC file 220. Next, the system can use AI to translate 222 the original language CC file 220 into other languages, resulting in translated CC files 224. The system can then use AI to generate an AI translation voiceover 226 using the translated CC files 224 and/or the audio narration 226 generated from the text 206 data. The result is a compilation of audio translations with CC data 228, which is combined to form translated audio narration 230 of the audio/video 208 content.

The system can then, using the AI generated audio narration 214 and/or the original language CC file 220, use AI to generate exam questions 232. The resulting exam questions can be added to a pool of exam questions 234 of similar or related questions. The system can translate 246 the exam questions within the exam question pool 234 using AI 238, resulting in translated exams 240. The system can then consolidate the translated exams 240, the translated audio narration 230, the compiled translated audio with CC 228, and/or the extracted text 212, resulting in a consolidated multi-language learning object with exam 242. This object (e.g., the combination of the translated exams 240, translated audio narration 230, compiled translated audio with CC 228, and/or the extracted text 212) can then be added to an LMS catalog as a new course 244. In practice, the object can be assembled in a way that the language options, CC options, and exam content are not considered add-ons or separate objects. Instead, they are part of a single unit and can be assigned as such. This makes use of the course in the LMS much simpler for the administrator in change of distribution.

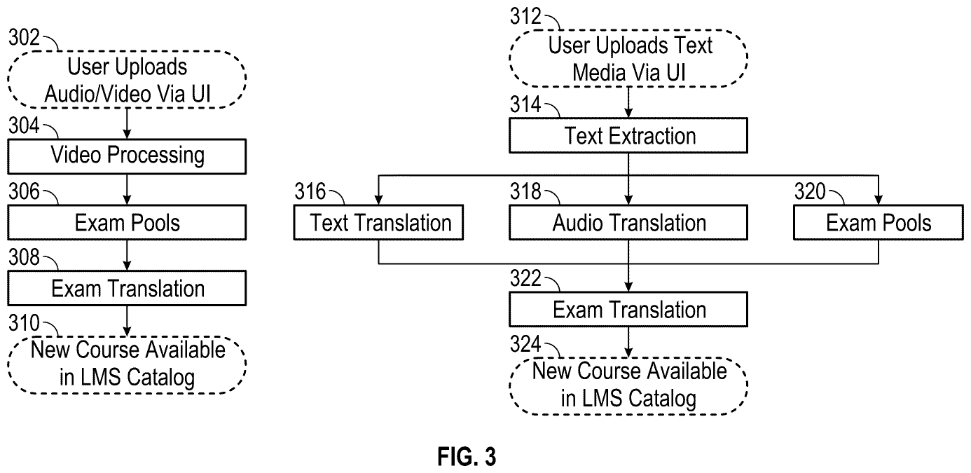

FIG. 3 illustrates an example of parallel processes within the system. As illustrated, the text and audio/video processes can occur simultaneously, in parallel with one another. On the left, as the user uploads audio/video via a UI 302, the system can begin the video processing 304, generating the questions which are entered into the exam question pools 306, and translating the exam 308. This can then result in a new course available in the LMS catalog 310. At the same time, the user may also upload text media via the UI 312. The UI used for the uploading of the audio/video media and the text media can be a singular UI. Likewise, the text may be related to the audio/video media, or may be unrelated. Upon receiving the text, the system can begin text extraction 314, followed by text translation 316, audio translation 318, and/or generating of questions based on the text for the exam pools 320. The text translation 316, audio translation 318, and/or generating of questions based on the text for the exam pools 320 can themselves occur in parallel with one another. Alternatively, the audio translation 318 may be delayed until the text translation 316 is complete when translation of the text, followed by generation of audio from the translations, is more computationally efficient. Upon completing the text translation 316, audio translation 318, and/or generating of questions based on the text for the exam pools 320, the system can translate the resulting exams 322, and a new course can be made available in the LMS catalog 324.

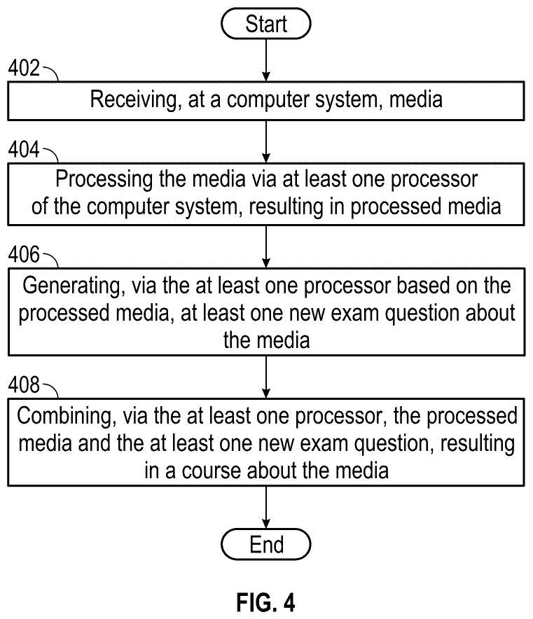

FIG. 4 illustrates an example method embodiment. As illustrated, the method includes receiving, at a computer system, media (402), and processing the media via at least one processor of the computer system, resulting in processed media (404). The method then includes generating, via the at least one processor based on the processed media, at least one new exam question about the media (406), and combining, via the at least one processor, the processed media and the at least one new exam question, resulting in a course about the media (408).

In some configurations, the illustrated method can further include storing the course in a database. In such configurations, the database can have additional courses stored therein.

In some configurations, the media comprises text; and the processing of the media comprises at least one of artificial intelligence (AI) text extraction and AI generated audio narration of the media.

In some configurations, the media can include at least one of audio and video; and the processing of the media can include at least one of: generating new closed captioning data from an audio track, translating the new closed captioning data, translating existing closed captioning data, and generating an AI translation voiceover which is combined with the media.

In some configurations, the generating of the new exam questions can include: accessing a pool of existing exam questions; and generating, via the at least one processor using at least one question from the pool of existing exam questions as a template, the at least one new exam question.

In some configurations, wherein the processing of the media further can further include: transmitting at least a portion of the media from the computer system with a processing request to a remote computing system; and receiving, at the computer system from the remote computing system in response to the processing request, at least a portion of the processed media.

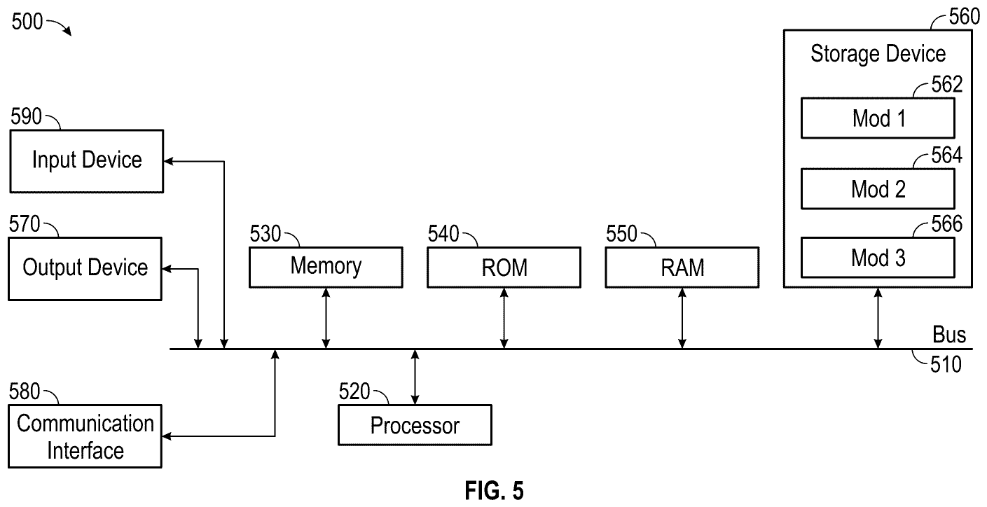

With reference to FIG. 5, an exemplary system includes a computing device 500 (such as a general-purpose computing device), including a processing unit (CPU or processor) 520 and a system bus 510 that couples various system components including the system memory 530 such as read-only memory (ROM) 540 and random access memory (RAM) 550 to the processor 520. The computing device 500 can include a cache of high-speed memory connected directly with, in close proximity to, or integrated as part of the processor 520. The computing device 500 copies data from the system memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The system memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in memory ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, system bus 510, output device 570 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 500 is a small, handheld computing device, a desktop computer, or a computer server.

Although the exemplary embodiment described herein employs the storage device 560 (such as a hard disk), other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, media; processing the media via at least one processor of the computer system, resulting in processed media; generating, via the at least one processor based on the processed media, at least one new exam question about the media; and combining, via the at least one processor, the processed media and the at least one new exam question, resulting in a course about the media.

The method of any preceding clause, further comprising: storing the course in a database.

The method of any preceding clause, wherein the database has additional courses stored therein.

The method of any preceding clause, wherein: the media comprises text; and the processing of the media comprises at least one of artificial intelligence (AI) text extraction and AI generated audio narration of the media.

The method of any preceding clause, wherein: the media comprises at least one of audio and video; and the processing of the media comprises at least one of: generating new closed captioning data from an audio track, translating the new closed captioning data, translating existing closed captioning data, and generating an AI translation voiceover which is combined with the media.

The method of any preceding clause, wherein the generating of the new exam questions comprises: accessing a pool of existing exam questions; and generating, via the at least one processor using at least one question from the pool of existing exam questions as a template, the at least one new exam question.

The method of any preceding clause, wherein the processing of the media further comprises: transmitting at least a portion of the media from the computer system with a processing request to a remote computing system; and receiving, at the computer system from the remote computing system in response to the processing request, at least a portion of the processed media.

A system comprising: at least one processor; and a non-transitory computer-readable storage medium having instructions stored which, when executed by the at least one processor, cause the at least one processor to perform operations comprising: receiving media; processing the media, resulting in processed media; generating, based on the processed media, at least one new exam question about the media; and combining the processed media and the at least one new exam question, resulting in a course about the media.

The system of any preceding clause, the non-transitory computer-readable storage medium having additional instructions stored which, when executed by the at least one processor, cause the at least one processor to perform operations comprising: storing the course in a database.

The system of any preceding clause, wherein the database has additional courses stored therein.

The system of any preceding clause, wherein: the media comprises text; and the processing of the media comprises at least one of artificial intelligence (AI) text extraction and AI generated audio narration of the media.

The system of any preceding clause, wherein: the media comprises at least one of audio and video; and the processing of the media comprises at least one of: generating new closed captioning data from an audio track, translating the new closed captioning data, translating existing closed captioning data, and generating an AI translation voiceover which is combined with the media.

The system of any preceding clause, wherein the generating of the new exam questions comprises: accessing a pool of existing exam questions; and generating, using at least one question from the pool of existing exam questions as a template, the at least one new exam question.

The system of any preceding clause, wherein the processing of the media further comprises: transmitting at least a portion of the media with a processing request to a remote computing system; and receiving, from the remote computing system in response to the processing request, at least a portion of the processed media.

A non-transitory computer-readable storage medium having instructions stored which, when executed by at least one processor, cause the at least one processor to perform operations comprising: receiving media; processing the media, resulting in processed media; generating, based on the processed media, at least one new exam question about the media; and combining the processed media and the at least one new exam question, resulting in a course about the media.

The non-transitory computer-readable storage medium of any preceding clause, having additional instructions stored which, when executed by the at least one processor, cause the at least one processor to perform operations comprising: storing the course in a database.

The non-transitory computer-readable storage medium of any preceding clause, wherein the database has additional courses stored therein.

The non-transitory computer-readable storage medium of any preceding clause, wherein: the media comprises text; and the processing of the media comprises at least one of artificial intelligence (AI) text extraction and AI generated audio narration of the media.

The non-transitory computer-readable storage medium of any preceding clause, wherein: the media comprises at least one of audio and video; and the processing of the media comprises at least one of: generating new closed captioning data from an audio track, translating the new closed captioning data, translating existing closed captioning data, and generating an AI translation voiceover which is combined with the media.

The non-transitory computer-readable storage medium of any preceding clause, wherein the generating of the new exam questions comprises: accessing a pool of existing exam questions; and generating, using at least one question from the pool of existing exam questions as a template, the at least one new exam question.

We claim:

1. A method comprising:
receiving, at a computer system, media;
processing the media via at least one processor of the computer system, resulting in processed media;
generating, via the at least one processor based on the processed media, at least one new exam question about the media; and
combining, via the at least one processor, the processed media and the at least one new exam question, resulting in a course about the media.

2. The method of claim 1, further comprising:
storing the course in a database.

3. The method of claim 2, wherein the database has additional courses stored therein.

4. The method of claim 1, wherein:
the media comprises text; and
the processing of the media comprises at least one of artificial intelligence (AI) text extraction and AI generated audio narration of the media.

5. The method of claim 1, wherein:
the media comprises at least one of audio and video; and
the processing of the media comprises at least one of: generating new closed captioning data from an audio track, translating the new closed captioning data, translating existing closed captioning data, and generating an AI translation voiceover which is combined with the media.

6. The method of claim 1, wherein the generating of the new exam questions comprises:
accessing a pool of existing exam questions; and
generating, via the at least one processor using at least one question from the pool of existing exam questions as a template, the at least one new exam question.

7. The method of claim 1, wherein the processing of the media further comprises:
transmitting at least a portion of the media from the computer system with a processing request to a remote computing system; and
receiving, at the computer system from the remote computing system in response to the processing request, at least a portion of the processed media.

8. A system comprising:
at least one processor; and
a non-transitory computer-readable storage medium having instructions stored which, when executed by the at least one processor, cause the at least one processor to perform operations comprising:
receiving media;
processing the media, resulting in processed media;
generating, based on the processed media, at least one new exam question about the media; and
combining the processed media and the at least one new exam question, resulting in a course about the media.

9. The system of claim 8, the non-transitory computer-readable storage medium having additional instructions stored which, when executed by the at least one processor, cause the at least one processor to perform operations comprising:
storing the course in a database.

10. The system of claim 9, wherein the database has additional courses stored therein.

11. The system of claim 8, wherein:
the media comprises text; and
the processing of the media comprises at least one of artificial intelligence (AI) text extraction and AI generated audio narration of the media.

12. The system of claim 8, wherein:
the media comprises at least one of audio and video; and
the processing of the media comprises at least one of: generating new closed captioning data from an audio track, translating the new closed captioning data, translating existing closed captioning data, and generating an AI translation voiceover which is combined with the media.

13. The system of claim 8, wherein the generating of the new exam questions comprises:
accessing a pool of existing exam questions; and
generating, using at least one question from the pool of existing exam questions as a template, the at least one new exam question.

14. The system of claim 8, wherein the processing of the media further comprises:
transmitting at least a portion of the media with a processing request to a remote computing system; and
receiving, from the remote computing system in response to the processing request, at least a portion of the processed media.

15. A non-transitory computer-readable storage medium having instructions stored which, when executed by at least one processor, cause the at least one processor to perform operations comprising:
receiving media;
processing the media, resulting in processed media;
generating, based on the processed media, at least one new exam question about the media; and
combining the processed media and the at least one new exam question, resulting in a course about the media.

16. The non-transitory computer-readable storage medium of claim 15, having additional instructions stored which, when executed by the at least one processor, cause the at least one processor to perform operations comprising:
storing the course in a database.

17. The non-transitory computer-readable storage medium of claim 16, wherein the database has additional courses stored therein.

18. The non-transitory computer-readable storage medium of claim 15, wherein:
the media comprises text; and
the processing of the media comprises at least one of artificial intelligence (AI) text extraction and AI generated audio narration of the media.

19. The non-transitory computer-readable storage medium of claim 15, wherein:
the media comprises at least one of audio and video; and
the processing of the media comprises at least one of: generating new closed captioning data from an audio track, translating the new closed captioning data, translating existing closed captioning data, and generating an AI translation voiceover which is combined with the media.

20. The non-transitory computer-readable storage medium of claim 15, wherein the generating of the new exam questions comprises:
accessing a pool of existing exam questions; and
generating, using at least one question from the pool of existing exam questions as a template, the at least one new exam question.
